(19) United States
(12) Patent Application Publication
(10) Pub. No.: US 2018/0282191 A1
(43) Pub. Date: Oct. 4, 2018

(54) METHOD FOR BIOLOGICAL REMOVAL OF SULFIDES FROM WATER

(71) Applicant: UOP LLC, Des Plaines, IL (US)

(72) Inventors: Francis Stephen Lupton, Evanston, IL (US); William Sheridan, Naperville, IL (US)

(21) Appl. No.: 15/994,982

(22) Filed: May 31, 2018

Related U.S. Application Data
(63) Continuation of application No. PCT/US2016/063088, filed on Nov. 21, 2016.
(60) Provisional application No. 62/268,647, filed on Dec. 17, 2015.

(51) Int. Cl. C02F 3/34; C02F 3/10; B01D 53/84; B01D 53/52

(52) U.S. Cl. CPC C02F 3/345; C02F 3/10; C02F 2101/101; B01D 53/52; B01D 53/84

(57) ABSTRACT

A method is presented for biological removal of contaminants like sulfide from ground waters and industrial waters. Sulfide oxidizing bacteria by biological oxidation oxidizes sulfides in water to produce soluble sulfates. The present invention uses a packed bed bioreactor configuration that uses packing material to maximize the concentration of sulfide oxidizing bacteria.

### CROSS-REFERENCE TO RELATED APPLICATIONS

This application is a Continuation of copending International Application No. PCT/US2016/063088 filed Nov. 21, 2016, which application claims priority from U.S. Provisional Application No. 62/268,647 filed Dec. 17, 2015, now expired, the contents of which cited applications are hereby incorporated by reference in their entirety.

### BACKGROUND

The present invention relates generally to method for the removal of pollutants from water. More specifically, the present invention relates to methods for biological removal of sulfides from high salinity ground waters and industrial wastewaters.

Environment-conscious industries are continuously laboring toward the goal of removing pollutants from contaminated water to make the water safe at both the ground level and the consumer level. Government-regulated agencies establish limits for many common industrial pollutants. These limits tend to become stricter as pollutant reduction and removal technology proves effective at accomplishing previously-established requirements. Consequently, both ground and consumer level water continue to improve in terms of both purity and safety.

Among the methods employed to reduce and remove pollutants, bioremediation constitutes an effective and desirable technology. In a broad sense, bioremediation includes the use of microorganisms that digest pollutants as a source of food, including nitrogen and carbon compounds. Bacterial metabolism can convert the pollutants to metabolites having a simple chemical structure to carbon dioxide and water in an aerobic process, or to methane in an anaerobic process. In any respect, the metabolites produced by bacteria typically have no adverse environmental effects.

The use of large volumes of water in hydraulic fracturing or “fracking,” a technique to enhance the recovery of natural gas from organic containing shale deposits, has led to restrictions on use of fresh water reserves both above ground and from potable ground waters. The use of non-potable deep ground water brines for fracking does not put a strain on these fresh water reserves, but it does introduce new challenges, especially with regards to high levels of hydrogen sulfide present in brines. Several chemical processes have been developed, including chemical oxidation or stripping/adsorption techniques for sulfide removal from waste water, but they tend to be relatively expensive and require an undesirably large amount of time, machinery and high operational costs. Sludge disposal is one of major operating costs of biological treatment systems. The use of sulfur oxidizing bacteria that produces elemental sulfur in a suspended growth system produces large amounts of solids that contribute to sludge formation of both elemental sulfur solids and biological solids.

Therefore, there is a need for an improved method and apparatus for removing sulfides from waste water in a cost and time efficient manner. It is also desirable to provide such methods and systems that can replace some conventional chemical processes for removal of sulfides with improved biological processes and thereby reduce the requisite time, machinery, and operational costs for performing the processes.

### SUMMARY

An embodiment of the present invention is a process for removing sulfides from a water stream in a bioreactor wherein the water stream contains from about 1 mg/L to about 2500 mg/L of sulfur compounds on an elemental sulfur basis, comprising passing the water stream through a fixed film bioreactor containing an effective quantity of autotrophic obligate chemolithotrophic bacteria immobilized on a packing material within the bioreactor. The sulfides are oxidized to sulfates. Air is circulated to the bioreactor to provide oxygen to the bacteria and the air containing sulfides that volatilized into a gas phase into air are removed. A portion of the air containing sulfides is recycled to the bioreactor to allow residual sulfides within the recycled air to be oxidized by the bacteria. A purified water stream comprising less than about 0.5 mg/L sulfides are removed from the bioreactor.

The present invention seeks to provide a process for removing sulfides from a water stream in a bioreactor in a cost and time efficient manner. A benefit of the present invention is that the process of biological oxidation of sulfide is faster than prior art processes and produces soluble sulfates rather than elemental sulfur which are problematic in removal of sulfide from saline groundwater. The process advantageously avoids solid separation and disposal issues. These and other features, aspects, and advantages of the present invention will become better understood upon consideration of the following detailed description, drawings and appended claims.

### BRIEF DESCRIPTION OF THE DRAWINGS

FIG. 1 is a schematic for the process of an embodiment of the present invention.

FIG. 2 is a cross-sectional view of a biologically active component that is used to remove pollutants from waste water in accordance with an embodiment of the present invention.

### DETAILED DESCRIPTION

The microbial oxidation of reduced sulfur species by the use of bacteria, especially photosynthetic bacteria, to oxidize sulfide to elemental sulfur in a suspended growth mode is known. Bacteria have developed enzymes which are orders of magnitude more efficient than abiotic oxidation of sulfides by molecular oxygen. The present invention provides a method of using non-photosynthetic chemolithotrophic sulfur oxidizing bacteria that can oxidize sulfide to soluble sulfate rather than elemental sulfur. The bacterium that oxidizes sulfides to elemental sulfur often produces granules of sulfur so that sulfur is retained in the biomass.

The autotrophic obligate chemolithotrophic bacteria that are used in the present invention are a group of bacteria that gain metabolic energy from the oxidization of reduced sulfur compounds instead of gaining energy from the oxidation of organic compounds, unlike most other organisms. They grow by fixing carbon dioxide into organic compounds just like photosynthetic organisms. They use chemical energy from sulfide oxidation rather than light energy to do this biochemical step. The biochemical process involved in the mechanism are illustrated below:

The chemolithotrophic bacteria used in the present invention are obligatory halotolerant and acidophilic. The bacteria may be found in marine or saline environments with salt concentration in excess of 1% total salinity. The optimal area to select the bacteria of the present invention is at the water/sediment interface, where the bacteria have access to both sulfide and oxygen.

The autotrophic obligate chemolithotrophic bacteria used in the present invention may be selected from the following species Acidithiobacillus ferrooxidans, Thermithiobacillus tepidarius, Sulfurimonas denitrificans, Desulfocapsa sulfoexigens, and some species of Thiobacillus, Halothiobacillus, Acidiphilium, Thiomicrospira, Sulfolobus, Acidianus, Sulfurisphaera, and Sulfurococcus. The chemolithotrophic sulfur oxidizing bacteria of the present invention can fully and efficiently oxidize sulfides to soluble sulfates.

The present invention provides a high performance bioreactor system that can be used to remove organics and sulfides from both gas and water streams using a proprietary bio-support and reactor design. The bioreactor system may be used to remove sulfide from sewer vent gas and organics formed during treatment of metal containing mining wastes. The bioreactor of the present invention is robust and provides cost effective solution for removal of sulfide from polluted water.

The present invention uses a packed bed bioreactor configuration that uses two different packing materials. The packing used may be dual or mixed media packing. The packing used according to the present invention allows the buildup of high concentrations of obligatory halotolerant acidophilic, chemolithotrophic bacteria in the bioreactor to develop in microbial biofilms. The chemolithotrophic bacteria may colonize in the dual packing material in the fixed film bioreactor to high concentration of about 10,000 mg/L of fixed biomass. The packing used in the bioreactor also minimizes plugging and enables to maximize the contact between the sulfide and bacteria. The mixed media packing may be a mixture of polyurethane foam and plastic ball rings.

The oxidation of sulfide to elemental sulfur results in formation of alkaline conditions:

HS⁻+½O₂→S⁰+OH⁻

Alkaline conditions in the saline groundwaters results in scaling due to formation of calcium salts. The oxidation of sulfide by the chemolithotrophic sulfur oxidizing bacteria on the other hand produces acidic conditions which helps prevent the scaling problem in the highly saline groundwaters.

HS⁻+2O₂→SO₄²⁻+H⁺

The present invention provides a method to immobilize the bacteria in highly porous support matrix that prevents loss of bacteria and also reduces the solids leaving the bioreactor. The prevention of scaling problems allows the water to be used directly from the bioreactor as make-up water for fracking without any additional post-treatments like filtration. Further, the sulfides are conventionally known to volatize into gas phase when air is added. The sulfides generally strip into the gas phase to provide oxygen for the chemolithotrophic sulfide oxidizing bacteria. The scrubbing of sulfide from large volumes of air is problematic and expensive. The present invention provides beneficially a design and process that allows for recycling of air to prevent the loss of stripped sulfide from the system.

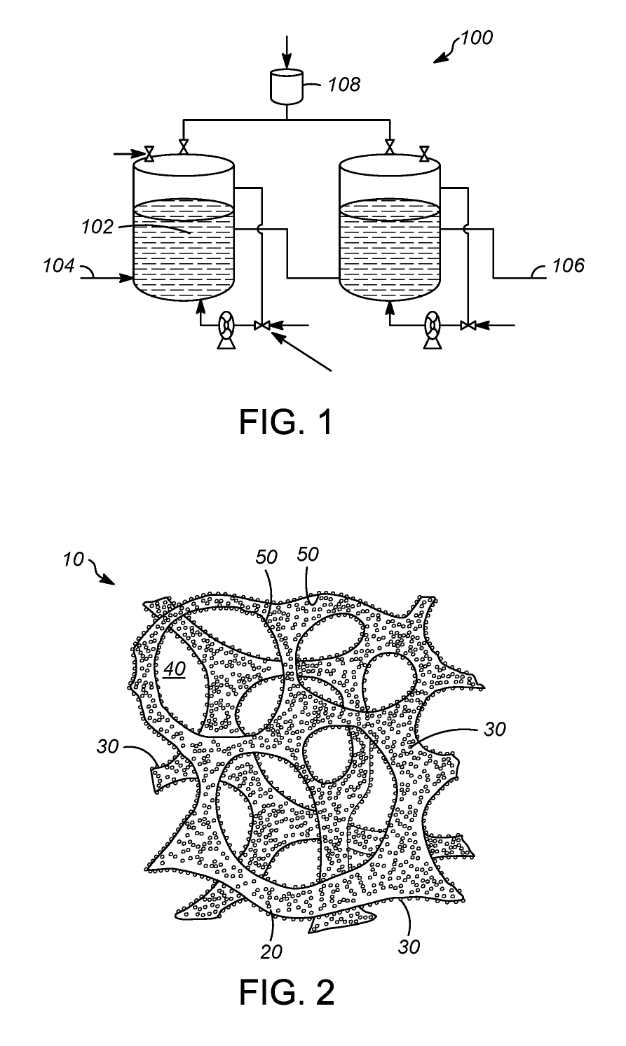

A general understanding of the apparatus and process that allows recycling of air to prevent the loss of stripped sulfide from the system can be obtained by reference to FIG. 1. FIG. 1 has been simplified by the deletion of a large number of apparatuses customarily employed in a process of this nature, such as vessel internals, temperature and pressure controls systems, flow control valves, recycle pumps, etc. which are not specifically required to illustrate the performance of the present invention. FIG. 1 shows two bioreactors as a representation, but the process of the present invention is not limited to two reactors. Furthermore, the illustration of the process of this present invention in the embodiment of a specific drawing is not intended to limit the present invention to specific embodiments set out herein.

The immobilized cell bioreactor (ICB) 100 comprises a chamber 102, including a first inlet in line 104 for receiving the feed and a first outlet in line 106 for releasing the effluent. The feed to the bioreactor may be an aqueous stream containing sulfides. Typical feeds include briny groundwaters, fracking wastewaters, sulfidic caustic wastewaters, sour waters from refining and petrochemical processing, sulfidic sewer water, and sour water generated by anaerobic digesters or mixtures thereof. The feed water stream may comprise a salt concentration of more than 1% total salinity. The concentration of sulfide in the feed to the bioreactor may be about 1 mg/L to about 3000 mg/L and preferably in the range of about 10 mg/L to about 1,600 mg/L. The sulfides may be present in the feed as hydrogen sulfide or metallic sulfides such as sodium sulfide or iron sulfides. The chemolithotrophic bacteria may be supported on a substrate housed inside the chamber in a fixed bed and situated to contact with the feed flowing there through. The autotrophic obligate chemolithtrophic bacteria are immobilized on a packing material within the bioreactor. The term “fixed bed” signifies that the biologically active components and the bacteria supported thereon are substantially stationary as the feed flows through the bioreactor. The biologically active components are primarily a porous substrate. Fresh air comprising oxygen may be added to the bioreactor when the concentration of oxygen dissolved in the water is less than about 2 mg/L. The sulfide containing feed is allowed to flow upflow through the packed bed of the bioreactor along with air. The air provides oxygen to the autotrophic obligate chemolithtrophic bacteria. The sulfides are oxidized to soluble sulfate by the chemolithotrophic bacteria in the bioreactor. The addition of fresh air 130 is through valves 140 and blowers 150 to the bottom of the bioreactor. The air flows co-currently with the flow of water up through the packed bed. The air disengages from the water at the top of the reactor. A portion of the air which contains sulfides is recycles back through line 170 through the Blower 150 to the bottom of the bioreactor. A portion of the air inside the bioreactor will be displaced by the addition of new fresh air 130 entering through valve 140. The displaced air will be discharged through valve 160 leading to a sulfide scrubber 108 but the majority of sulfide is oxidized in the recirculating gas stream by the chemolithotrophic sulfur oxidizing bacteria immobilized on the bioreactor packing. The displaced air containing sulfides 120 that volatizes into a gas phase into air is removed from valves 160 and passes through scrubber 108. The sulfide free water is taken as the effluent from the bioreactor and may be used as fracking make-up water for discharge in the case of industrial waste water.

The stripped sulfide is recycled back from the headspace of the bioreactor through the packed bed with immobilized chemolithotrophic bacteria to provide enough time for the bacteria to oxidize the sulfide at air or water surface. This allows multiple passes of the stripped sulfide through the packed bed. The stripped sulfide is re-dissolved in the aqueous phase and may be oxidized by the autotrophic obligate chemolithtrophic bacteria. The recycling of air containing the sulfide enables maximizing the biological oxidation of sulfide and minimizes the venting of sulfide in a single pass aeration system. Fresh air may be periodically passed into the bioreactor to replace the oxygen consumed by the chemolithotrophic bacteria during oxidation of sulfides. Water may be added to the bioreactor to remove the soluble sulfates. The purified effluent stream from the bioreactor comprises reduced sulfide concentration to about less than 0.5 mg/L and preferably of about less than 0.2 mg/L. The purified effluent water may be reused in an industrial process or discharged into nearby ground water. Table 1 shows experimental data for the concentration of sulfide present in effluent of the bioreactor in comparison to feed.

TABLE 1
Concentration in mg/L

| Sulfide in Feed | Sulfide in Effluent |
|---|---|
| 42.2 | 0.2 |
| 47 | 0.27 |
| 50 | 0.2 |
| 123 | 0.19 |
| 51 | 0.1 |
| 63 | 0.08 |
| 59 | 0.08 |
| 781 | 0.05 |
| 1,674 | 0.125 |
| 1,645 | 0.066 |
| 1,464 | 0.257 |
| 455 | 0.014 |
| 146 | 0.008 |
| 380 | 0.064 |
| 465 | 0.074 |
| 502 | 0.009 |
| 456 | 0.005 |
| 2 | 0.025 |
| 57 | 0.117 |
| 144 | 0.144 |
| 158 | 0.122 |
| 108 | 0.119 |
| 1 | 0.042 |
| 70 | 0.048 |
| 109 | 0.022 |
| 101 | 0.018 |
| 136 | 0.031 |

The recycle air may be discharged through a scrubber to remove residual sulfide before gas is discharged to atmosphere. The scrubber may be a liquid adsorbent such as caustic solution, a solid adsorbent such as iron sponge or sulfatreat, or a biofilter of gaseous hydrogen sulfide.

FIG. 2 is a cross sectional view of an exemplary biologically active component 10. The biologically active component may be a porous substrate 20. The porous substrate 20 defines a web of walls having passages or voids 40 there between. The web-like structure provides a high surface area to volume ratio, and consequently supports a high concentration of microorganisms 30, typically colonized as a microbial biofilm, and including bacteria capable of metabolizing pollutants contained in the waste water stream. In an exemplary embodiment, at least part of the component substrate 20 includes an absorbent 50 or is otherwise provided with a capacity for absorbing one or more pollutant from the waste water stream to enhance pollutant biodegradation using the microorganisms 30. In another exemplary embodiment, the substrate itself is sufficiently absorbent for particular pollutants that a coating of absorbent is not necessary. Other optional materials may be included on or in the component surface 20, including cations and/or materials having positively charged groups, and density-increasing substances, density-reducing substances, coloring agents, and short fibers of an organic or inorganic base such as glass fibers and gel-forming macromolecular substances such as cellulose, alginate, starch, and carrageenan.

Each of the biologically active components 10 is a particulate having a size and shape that may vary widely from particulate to particulate. For example, the components 10 may have a regular shape such as a cube, rod, rectangle, sphere, spiral, or hexagon, or they may have an irregular shape. The particulate size may be anywhere between about 0.10 inch to about 12 inches. The amount of substrate 20 included in the components 10 may vary widely, although in general the amount of substrate 20 for each particulate is from about 50 to about 20 weight percent based on the total particulate weight, with the remaining weight percentage being primarily attributed to microorganisms 30 and any absorbent that may be included. The voids 40 are from about 40 to about 98 volume %. The substrate 20 is formed from any material capable of forming a porous particulate and supporting microorganisms 30. Inorganic materials and organic plastics are exemplary materials, including those disclosed in U.S. Pat. No. 5,217,616, which also discloses exemplary materials for other reactor components.

While the present invention has been described with what are presently considered the preferred embodiments, it is to be understood that the present invention is not limited to the disclosed embodiments, but it is intended to cover various modifications and equivalent arrangements included within the scope of the appended claims.

### SPECIFIC EMBODIMENTS

While the following is described in conjunction with specific embodiments, it will be understood that this description is intended to illustrate and not limit the scope of the preceding description and the appended claims.

A first embodiment of the invention is a process for removing sulfides from a water stream in a bioreactor wherein said water stream contains from about 1 mg/L to about 2500 mg/L of sulfur compounds on an elemental sulfur basis, comprising passing said water stream through a fixed film bioreactor containing a effective quantity of autotrophic obligate chemolithotrophic bacteria immobilized on a packing material within said bioreactor; oxidizing said sulfides to form sulfates; circulating air to said bioreactor to provide oxygen to said autotrophic obligate chemolithotrophic bacteria and removing air containing sulfides that volatilized into a gas phase into air; recycling at least a portion of said air containing sulfides to said bioreactor to allow residual sulfides within said recycled air to be oxidized by said autotrophic obligate chemolithotrophic bacteria; and removing a purified water stream comprising less than about 0.5 mg/L sulfides from said bioreactor. An embodiment of the invention is one, any or all of prior embodiments in this paragraph up through the first embodiment in this paragraph wherein said water stream is selected from the group consisting of briny ground water, fracking wastewater, sulfidic caustic wastewater, sour water from refining or from petrochemical processing, sulfidic sewer water, and sour water generated by anaerobic digesters and mixtures thereof. An embodiment of the invention is one, any or all of prior embodiments in this paragraph up through the first embodiment in this paragraph wherein autotrophic obligate chemolithotrophic bacteria are selected from the group consisting of Acidithiobacillus ferrooxidans, Thermithiobacillus tepidarius, Sulfurimonas denitrificans, Desulfocapsa sulfoexigens, and some species of Thiobacillus, Halothiobacillus, Acidiphilium, Thiomicrospira, Sulfolobus, Acidianus, Sulfurisphaera, and Sulfurococcus. An embodiment of the invention is one, any or all of prior embodiments in this paragraph up through the first embodiment in this paragraph wherein said purified water stream comprises less than about 0.2 mg/L sulfides. An embodiment of the invention is one, any or all of prior embodiments in this paragraph up through the first embodiment in this paragraph wherein sulfides within said air containing sulfides is re-dissolved into an aqueous phase and oxidized by said bacteria. An embodiment of the invention is one, any or all of prior embodiments in this paragraph up through the first embodiment in this paragraph further comprising sending a water stream through said bioreactor to remove soluble sulfates. An embodiment of the invention is one, any or all of prior embodiments in this paragraph up through the first embodiment in this paragraph wherein said air is circulated to said bioreactor when a concentration of oxygen dissolved in water within said bioreactor is less than about 2 mg/L. An embodiment of the invention is one, any or all of prior embodiments in this paragraph up through the first embodiment in this paragraph wherein a majority of sulfides within said water stream are oxidized to sulfates by said chemolithotrophic sulfur oxidizing bacteria. An embodiment of the invention is one, any or all of prior embodiments in this paragraph up through the first embodiment in this paragraph wherein said packing material contains about 10,000 mg/L of fixed biomass of said bacteria. An embodiment of the invention is one, any or all of prior embodiments in this paragraph up through the first embodiment in this paragraph wherein said water stream comprises a salt concentration of more than 1% total salinity. An embodiment of the invention is one, any or all of prior embodiments in this paragraph up through the first embodiment in this paragraph wherein said water stream and air flow through said autotrophic obligate chemolithotrophic bacteria. An embodiment of the invention is one, any or all of prior embodiments in this paragraph up through the first embodiment in this paragraph wherein said purified water is reused in an industrial process or discharged into nearby ground water.

Without further elaboration, it is believed that using the preceding description that one skilled in the art can utilize the present invention to its fullest extent and easily ascertain the essential characteristics of this invention, without departing from the spirit and scope thereof to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

1. A process for removing sulfides from a water stream in a bioreactor wherein said water stream contains from about 1 mg/L to about 3000 mg/L of sulfur compounds on an elemental sulfur basis, comprising:
(a) passing said water stream through a fixed film bioreactor containing a effective quantity of autotrophic obligate chemolithotrophic bacteria immobilized on a packing material within said bioreactor;
(b) oxidizing said sulfides to form sulfates;
(c) circulating air to said bioreactor to provide oxygen to said autotrophic obligate chemolithotrophic bacteria and removing air containing sulfides that volatilized into a gas phase into air;
(d) recycling at least a portion of said air containing sulfides to said bioreactor to allow residual sulfides within said recycled air to be oxidized by said autotrophic obligate chemolithotrophic bacteria; and
(e) removing a purified water stream comprising less than about 0.5 mg/L sulfides from said bioreactor.

2. The process of claim 1 wherein said water stream is selected from the group consisting of briny ground water, fracking wastewater, sulfidic caustic wastewater, sour water from refining or from petrochemical processing, sulfidic sewer water, and sour water generated by anaerobic digesters and mixtures thereof.

3. The process of claim 1 wherein said autotrophic obligate chemolithotrophic bacteria are selected from the group consisting of Acidithiobacillus ferrooxidans, Thermithiobacillus tepidarius, Sulfurimonas denitrificans, Desulfocapsa sulfoexigens, and some species of Thiobacillus, Halothiobacillus, Acidiphilium, Thiomicrospira, Sulfolobus, Acidianus, Sulfurisphaera, and Sulfurococcus.

4. The process of claim 1 wherein said purified water stream comprises less than about 0.2 mg/L sulfides.

5. The process of claim 1 wherein sulfides within said air containing sulfides is re-dissolved into an aqueous phase and oxidized by said bacteria.

6. The process of claim 1 further comprising sending a water stream through said bioreactor to remove soluble sulfates.

7. The process of claim 1 wherein said air is circulated to said bioreactor when a concentration of oxygen dissolved in water within said bioreactor is less than about 2 mg/L.

8. The process of claim 1 wherein a majority of sulfides within said water stream are oxidized to sulfates by said chemolithotrophic sulfur oxidizing bacteria.

9. The process of claim 1 wherein said packing material contains about 10,000 mg/L of fixed biomass of said bacteria.

10. The process of claim 1 wherein said water stream comprises a salt concentration of more than 1% total salinity.

11. The process of claim 1 wherein said water stream and air flow through said autotrophic obligate chemolithotrophic bacteria.

12. The process of claim 2 wherein said purified water is reused in an industrial process or discharged into nearby ground water.
